(19) United States
(12) Patent Application Publication
(10) Pub. No.: US 2024/0326135 A1
(43) Pub. Date: Oct. 3, 2024

(54) SYSTEMS AND METHODS FOR BROADBAND WAVELENGTH MONITORING DURING ADDITIVE MANUFACTURING PROCESSES

(71) Applicant: VulcanForms Inc., Burlington, MA (US)

(72) Inventors: ALEXANDER DUNBAR, Watertown, MA (US); Michael von Dadelszen, Merrimack, NH (US); Andrew Gregory Przyjemski, Somerville, MA (US)

(73) Assignee: VulcanForms Inc., Burlington, MA (US)

(21) Appl. No.: 18/621,613

(22) Filed: Mar. 29, 2024

Related U.S. Application Data
(60) Provisional application No. 63/456,281, filed on Mar. 31, 2023.

(51) Int. Cl. B22F 12/90; B22F 10/28; B22F 10/36; B23K 26/03; B23K 26/342; B23K 26/70; B33Y 50/02; G01N 21/64

(52) U.S. Cl. CPC B22F 12/90; B22F 10/36; B23K 26/032; B23K 26/342; B23K 26/705; B33Y 50/02; G01N 21/6402; B22F 10/28; G01N 2201/0636

(57) ABSTRACT

Systems and methods for monitoring light emitted from a build surface as well as other sources during an additive manufacturing process are disclosed. Systems and methods for monitoring laser energy directed towards a build surface during an additive manufacturing process are also disclosed.

### RELATED APPLICATIONS

This application claims priority under 35 U.S.C. § 119 (e) to U.S. Provisional Application No. 63/456,281, filed Mar. 31, 2023, the content of which is incorporated by reference in its entirety for all purposes.

### FIELD

Disclosed embodiments are generally related to systems and methods for broadband wavelength monitoring during additive manufacturing processes.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources to create a desired two-dimensional geometry of solidified material within the layer. During fusing of the material, wavelengths of light may be emitted from the build surface either due to reflectance of a portion of the incident laser energy, emission of light from the high temperature melt pool, and/or from other appropriate sources. During part formation, the build surface may be indexed, and another layer of precursor material may be deposited. For example, in conventional systems, the build surface may be indexed downwardly by a distance corresponding to a thickness of a layer. This process may be repeated layer-by-layer to fuse many two-dimensional layers into a three-dimensional object.

### SUMMARY

In some embodiments, a method for monitoring an additive manufacturing process comprises directing laser energy from one or more laser energy sources onto a build surface, emitting and/or reflecting light from the build surface including a plurality of wavelengths of light, and splitting the emitted light into at least a first range of wavelengths of light and a second range of wavelengths of light different from the first range of wavelengths of light. The method may further comprise sensing the first range of wavelengths of light with a first photosensitive detector and sensing the second range of wavelengths of light with a second photosensitive detector.

In some embodiments, an additive manufacturing system comprises a build surface and one or more laser energy sources configured to direct laser energy onto the build surface, wherein light is emitted from the build surface including a plurality of wavelengths upon exposure to the laser energy. The additive manufacturing system further comprises a first beam splitter configured to split the emitted light into at least a first range of wavelengths of light and a second range of wavelengths of light different from the first range of wavelengths of light. The additive manufacturing system further comprises a first photosensitive detector coupled to the first beam splitter, wherein the first photosensitive detector is configured to sense the first range of wavelengths of light and a second photosensitive detector coupled to the first beam splitter, wherein the second photosensitive detector is configured to sense the second range of wavelengths of light.

In some embodiments, a method for monitoring an additive manufacturing process comprises directing laser energy from one or more laser energy sources onto a build surface and emitting light from the build surface including a plurality of wavelengths of light. The method may further comprise diffracting the emitted light into a range of separate wavelengths of light and sensing the separate wavelengths of light on separate portions of a photosensitive detector.

In some embodiments, an additive manufacturing system comprises a build surface and one or more laser energy sources configured to direct laser energy onto the build surface, wherein light is emitted from the build surface including a plurality of wavelengths upon exposure to the laser energy. The additive manufacturing system further comprises a diffractive optical element configured to diffract the emitted light into a range of separate wavelengths of light and a photosensitive detector configured to sense the separate wavelengths of light on separate portions of the photosensitive detector.

In some embodiments, a method for monitoring an additive manufacturing process comprises directing laser energy from one or more laser energy sources onto a build surface and directing a portion of the laser energy prior to the laser energy being incident on the build surface towards a photosensitive detector. The method further comprises sensing the portion of the laser energy with the photosensitive detector and determining one or more parameters of the laser energy based at least in part on the sensed portion of the laser energy.

In some embodiments, an additive manufacturing system comprises a build surface, one or more laser energy sources configured to direct laser energy onto the build surface, and a beam splitter disposed between the one or more laser energy sources and the build surface configured to direct a portion of the laser energy towards a photosensitive detector, wherein the photosensitive detector is configured to sense the portion of the laser energy. The additive manufacturing system further comprises a processor configured to determine one or more parameters of the laser energy based at least in part on the sensed portion of the laser energy.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows the optical paths present in an additive manufacturing system according to some embodiments;

FIG. 3 shows an additive manufacturing system according to some embodiments;

FIG. 4 shows a monitoring system for an additive manufacturing system according to some embodiments;

FIG. 5A shows a monitoring system including a diffractive optical element for an additive manufacturing system according to some embodiments;

FIG. 5B shows a monitoring system including a grating surface for an additive manufacturing system according to some embodiments;

FIG. 6 shows a monitoring system including multiple beam splitters for an additive manufacturing system according to some embodiments;

FIG. 7A shows an embodiment of melt pools being imaged with a two-dimensional array of pixels according to some embodiments; and

FIG. 7B shows an embodiment of melt pools being imaged with a one-dimensional array of pixels according to some embodiments.

### DETAILED DESCRIPTION

Some additive manufacturing processes may use a plurality of laser energy sources to direct laser energy onto precursor material disposed on a build surface. The laser energy may weld, sinter, react, or otherwise fuse the precursor material to form a desired cross section of a part within a given layer of material. The precursor material may be a metallic, ceramic, polymer, and/or composite powder capable of being fused to form a part. In some systems (e.g., laser powder bed fusion (LPBF)), laser energy, or other appropriate form of energy, heats and melts the precursor material, forming a melt pool. Wavelengths of light (e.g., ultraviolet (UV) light, visible light, infrared (IR) light, and others) may be emitted from the melt pool. The wavelengths of light resulting from the fusion of precursor material may vary depending on the conditions of the fusion which may be associated with certain parameters of the additive manufacturing system. Accordingly, the wavelengths of light may be measured and analyzed to collect information on the fusion and the additive manufacturing system.

Some systems utilize reflective elements and optical systems to help to inspect emissions from a build surface, however the reflective elements and optical systems are typically tuned to the sensing certain wavelengths of light, and are typically limited to measuring wavelengths associated with the laser energy (e.g., 900 nm to 1200 nm) used to fuse the precursor material. This correspondingly limits measurement and analysis of wavelengths to the range of wavelengths associated with the laser energy. However, measuring and analyzing different ranges of wavelength of light may provide additional information related to an additive manufacturing process. For example, it may be desirable to measure parameters associated ultraviolet (UV) light, visible light, infrared (IR) light, and/or any other appropriate range of wavelengths to collect information related to the fusion of material in an additive manufacturing system. For example, sensing visible light may help to provide a first set of information regarding the build process, and sensing IR light may help to provide a second set of information regarding the build process. Both the first set of information and the second set of information may be used to help to determine the quality of the build process in different ways. Some systems attempt to measure multiple ranges of wavelengths by manually calibrating separate measurement systems to sense certain ranges of wavelengths associated with each of the laser energy pixels. However, as the number of laser energy pixels increase in a system, this may become both costly and burdensome to provide separate sensors appropriately calibrated to the reference frame of the system. Alternatively, some systems may use multiple separate sensors associated with the different portions of a build surface though this may typically be associated with reduced resolution and the use of separate calibrations for the different portions of the build surface.

In view of the above, the Inventors have recognized the benefits associated with systems that may facilitate the measurement of different ranges of wavelengths emitted from a build surface during a build process. This may include systems configured to measure any appropriate combination of wavelengths in any of the manners disclosed herein. This may allow a part being built to be inspected for multiple process signatures simultaneously in some embodiments. For example, this may allow for measurement of the select process parameters viewed through a plume emission from the build surface using wavelengths able to penetrate the plume as well as other wavelengths which may be associated with reflected laser energy, thermal responses, and/or other parameters related to the melt pool and weld formation of a part during a build process. These measurements may then be used in any appropriate manner to either control operation of a system, monitor quality of a build process, and/or for any other appropriate purpose.

As described above, measuring wavelengths of light emitted from a build surface may allow for monitoring of the quality of one or more parts being built. To sense or otherwise measure the wavelengths of light from the build surface, the light emitted from the build surface may be directed along an optical path to a photosensitive detector. In some embodiments, the optical path may include one or more pathways along which the light travels and the pathways may include one or more photosensitive detectors used to image the wavelengths of light. Depending on the embodiment, this may either include sensing multiple discrete wavelengths with a single photosensitive detector and/or with separate photosensitive detectors as elaborated on further below.

In view of the above, the Inventors have recognized different strategies for measuring a broad range of wavelengths of light. One such strategy involves splitting the light emitted from a build surface into different discrete ranges of wavelengths and sensing the light (e.g., imaging) associated with the different ranges of wavelengths. In some embodiments, each range of wavelengths of interest may be imaged by a separate photosensitive detector. In some embodiments, this may be done using appropriate filters and separate photosensitive detectors. In other embodiments, this may include diffracting the emitted light from the build surface into a continuous spectrum of wavelengths such that separate ranges of wavelengths may be measured or sensed by separate groups of pixels of a photosensitive detector. These potential embodiments may either be used separately or in combination with one another as elaborated upon below.

In some embodiments, wavelengths of light emitted from a build surface (e.g., from a melt pool or other feature on the build surface) may be split into separate discrete ranges of wavelengths for imaging by separate photosensitive detectors. For example, the light emitted from the build surface may be split into at least two or more discrete ranges of wavelengths. To split or otherwise separate the light emitted from the build surface into discrete ranges of wavelengths, one or more beam splitters which may be disposed along an optical path of the emitted light may be used. The optical paths may direct the emitted light to a beam splitter and the beam splitter may split the wavelengths of light into at least two discrete ranges of wavelengths. That is, splitting the emitted light may include directing the emitted light through one or more beam splitters. For example, a beam splitter may split a range of wavelengths into a first range of wavelengths and a second range of wavelengths. The first range of wavelengths and second range of wavelengths may be directed to two separate photosensitive detectors for sensing, though different numbers of beam splitters and associated photosensitive detectors are also contemplated. For example, a first photosensitive detector may be optically coupled to a beam splitter such that light within the first range of wavelengths is directed towards the first photosensitive detector and the first photosensitive detector may be configured to sense the first range of wavelengths of light. A second photosensitive detector may also be coupled to the beam splitter such that light within the second range of wavelengths is directed towards the second photosensitive detector. The second photosensitive detector may be configured to sense the second range of wavelengths of light. As described further elsewhere in this application, any appropriate number of optical paths, photosensitive detectors, beam splitters, filters, and any other appropriate optics may be used in such an embodiment as the disclosure is not so limited.

Any optics disposed along an optical path between any combination of a laser energy source, build surface, and photosensitive detector described herein may include one or more filters configured to filter a desired range of wavelengths. Further, all optical elements as described herein may be arranged in any appropriate manner as the disclosure is not so limited. A filter may be located (e.g., disposed) between a photosensitive detector and any target that is being monitored at any point along an optical path coupling the detector and a desired location for monitoring (e.g., between a beam splitter and/or diffractive optical element and a photosensitive detector). The optics may direct emitted light and/or a range of wavelengths towards a detector or other optics assembly. For example, the optics may be disposed on an optical path before or after a beam splitter, diffractive optical elements, diffuser, or any other appropriate arrangement. In some embodiments, one or more filters may be disposed between a beam splitter and a photosensitive detector. The filters as described herein may be any appropriate filter, including notch filters, low pass filters, high pass filters, bandpass filters, dichroic filters, any other appropriate filter, and any combination thereof.

In some embodiments, light emitted from a build surface (e.g., from a melt pool or other feature on the build surface) may be diffracted into a continuous spectrum of wavelengths of light for imaging and/or sensing. The light may be diffracted using one or more diffractive optical elements. The emitted light may follow an optical path to a diffractive optical element (e.g., the emitted light may be directed towards the diffractive optical element via a beam splitter, mirror, or any other appropriate optical element, and any combination thereof), and the diffractive optical element may be configured to diffract the emitted light into a continuous spectrum of wavelengths of light. Diffracting the emitted light into a continuous spectrum of wavelengths of light may allow for the separate wavelengths of light to be imaged using a single photosensitive detector, though the use of multiple photosensitive detectors is also contemplated. For example, a continuous spectrum of wavelengths may be directed onto a photosensitive detector, and different portions (e.g., groups of pixels) of the photosensitive detector may be configured to sense (e.g., image) separate ranges of wavelengths of light that are incident upon the different pixel groups. For example, a first portion of a photosensitive detector may be configured to sense a first range of wavelengths of light and a second portion of the photosensitive detector may be configured to sense a second range of wavelengths of light due to the location of the diffracted light on the photosensitive detector during operation of the system. In some embodiments, at least one of the first range of wavelengths of light and the second range of wavelengths of light may be diffracted into a range of separate wavelengths. The different portions of the photosensitive detector may comprise separate groups of pixels of the photosensitive detector. For example, the first portion of the photosensitive detector may include a first group of pixels and the second portion of the photosensitive detector may include a second group of pixels. It should be noted that the photosensitive detectors may have any appropriate number of portions used to sense different wavelengths of light as the disclosure is not so limited. In some embodiments, more than one photosensitive detector may be used as the disclosure is not so limited.

The aforementioned strategies involving splitting the emitted light and diffracting the emitted light may be combined in any appropriate manner. For example, light emitted from the build surface may be split using a beam splitter into a first range of wavelengths of light and a second range of wavelengths of light. The first range of wavelengths of light may then be diffracted using a diffractive optical element, the second range of wavelengths may be diffracted using a diffractive optical element, or both the first range of wavelengths of light and the second range of wavelengths may be diffracted using a diffractive optical element. Of course, in some embodiments where the light emitted from the build surface is split into more than two ranges of wavelengths of light any appropriate range of wavelengths of light or combination of ranges of wavelengths of light may be diffracted using a diffractive optical element as the disclosure is not so limited. Accordingly, it should be understood that the embodiments disclosed herein may include any appropriate combination and number of beam splitters and/or diffractive optical elements for sensing a desired set of ranges of wavelengths of light as the disclosure is not so limited.

In addition to the above, the inventors have also recognized benefits associated with monitoring the laser energy emitted by an additive manufacturing system towards a build surface. Monitoring laser energy may help to improve the quality of a build process of an additive manufacturing system. For example, certain defects may be associated with certain behaviors of laser energy. In some embodiments, one or more parameters associated with the laser energy may be measured and analyzed to predict weld defects. However, such monitoring has typically been done by indirect monitoring of the laser energy based on information obtained from measurements of the build surface. Therefore, the inventors have also recognized a desire to monitor laser energy prior to being incident on a build surface. Monitoring the laser energy prior to being incident on the build surface may allow for increased accuracy of measurements of the laser energy being emitted from the one or more laser energy sources by measuring the laser energy directly, rather than measuring the laser energy after the laser energy has interacted with the build surface. As described further below, a portion of the laser energy emitted from a laser energy source of an additive manufacturing system may be directed along an optical path towards a photosensitive detector at a location that is disposed upstream from a distal end portion of an optical assembly the laser energy is emitted from and prior to the laser energy being incident on the build surface. The photosensitive detector may sense the portion of the laser energy and one or more parameters of the laser energy may be determined based at least in part on the sensed portion of the laser energy. As described further elsewhere, the laser energy may be directed towards the photosensitive detector by one or more beam splitters, reflective surfaces, optics, combinations thereof, and/or any other appropriate type of optics.

In some embodiments, laser energy parameters that may be detected for a laser energy beam being transmitted between a laser energy source and build surface may include intensity, intensity per unit area, shape, size, and/or any other appropriate laser energy parameter. Intensity may correspond to any appropriate measure of intensity including, but not limited to, power, photon count, and/or other appropriate parameter associated with the laser energy. Intensity per unit area may correspond to an intensity measurement divided by an area of an associated laser energy pixel and/or measured area of the laser energy beam. The parameters associated with the laser energy are explained in further detail elsewhere.

In some embodiments, wavelengths of light of interest emitted during a build process of an additive manufacturing system may range from about 10 nm to about 1700 nm. For example, in one embodiment, emitted light may be diffracted into a range of separate wavelengths of light ranging from about 10 nm to about 1700 nm. In further embodiments, the wavelengths of light of interest may range from about 400 nm to about 1500 nm. In even further embodiments, the wavelengths of light of interest may range from about 400 nm to about 1700 nm. These ranges may include wavelengths of light emitted from plasma which may correspond to wavelengths of light within the near-infrared (NIR) range, wavelengths associated with laser energy incident on a build surface which may be within the short-wave infrared (SWIR) range, and/or other appropriate ranges of wavelengths of light associated with a build process and that may be sensed using the methods and systems disclosed herein. Specific ranges of wavelengths, as well as potential process parameters and information that may be associated with sensing light in these ranges of wavelengths is elaborated on further below.

In some embodiments, electromagnetic radiation, which may also be referred to as light, laser energy, radiation, or other similar terms may be referred to as corresponding to different ranges of wavelength. Electromagnetic radiation that may be sensed with the systems disclosed herein may have any appropriate range of wavelengths. For example, emitted electromagnetic radiation that may be sensed by the systems and methods disclosed herein may be between or equal to 10 nm to about 1700 nm. This may include near infrared (NIR), short wave infrared (SWIR), plasma, visible light, and ultraviolet (UV), each of which may have an associated range of wavelengths. In some embodiments, Ultraviolet (UV) wavelengths of light may range from about 10 nm to about 400 nm. In some embodiments, wavelengths of visible light may range from about 380 nm to about 700 nm. In some embodiments, wavelengths of NIR light may range from about 700 nm to about 1000 nm. In some embodiments, wavelengths of SWIR light may range from about 1000 nm to about 1700 nm. Further ranges of wavelengths of electromagnetic radiation are described below. One or more photosensitive detectors may be used to sense one or more of the ranges of wavelengths described above and/or below.

Specific applications of sensing different ranges of wavelengths of light are described below. However, it should be understood that these different ranges of wavelengths may either be sensed individually and/or they may be sensed together using one or more photosensitive detectors as the disclosure is not limited to sensing any specific range, or ranges, or wavelengths of light.

Wavelengths of light emitted from plasma which may be formed during fusing of material may range from about 400 nm to about 600 nm, which may be in a visible range of wavelengths of light. In some embodiments, the formation of plasma may result from overheated melt pools. Accordingly, sensed wavelengths of light emitted from plasma may indicate overheating of the melt pool. It should be understood that different emission wavelengths may be emitted for plasmas formed from different types of evaporated materials. Accordingly, wavelengths for monitoring in this wavelength range may be selected based on a material type to be fused. In addition to the above, sensing emissions in the above noted wavelength range which may be outside of the visible spectrum may help to provide a higher signal to noise ratio

As noted above, near infrared (NIR) wavelengths of light may range from about 700 nm to about 1000 nm. Sensing NIR range of wavelengths of light may indicate thermal responses associated with the melt pool and/or build surface. For example, sensed NIR wavelengths may be associated with changes in a temperature of a melt pool and/or the build surface. This range of wavelengths of light may be used to help to measure melt pool performance. In some embodiments, the sensed wavelengths of light may be on a similar size scale as the particles of precursor material on the build surface. In such an embodiment, the longer wavelengths in the NIR range may allow the sensor to sense through any condensate and/or ejected material products that may result from the weld.

In some embodiments, wavelengths of light emitted by the build surface may be in a range of wavelengths that overlap with a range of wavelengths of laser energy emitted by a laser energy source towards a build surface. This emitted light may therefore correspond to reflected laser energy that is not being absorbed by the melt pool. In some embodiments, this range of wavelengths may be from about 1050 nm to about 1100 nm, though other ranges of wavelengths associated with light emitted from a laser energy source may also be used. For example, in some embodiments, wavelengths of light from lasers used in laser powder bed fusion may typically range from about 1050 nm to about 1090 nm. In some embodiments, during keyhole mode welding absorption of the laser energy by the precursor material (which may be melted to form liquid metal) may be relatively high due to the topology of the melt pool, however during conduction mode welding a significantly greater portion of the laser energy may be reflected. Accordingly, conduction mode welding may result in a greater quantity of sensed wavelengths within the range of laser energy wavelengths. Thus, sensing light in these ranges of wavelengths may help to verify a quality and/or type of weld being formed by a melt pool. For example, in some embodiments, the present systems and methods may be used in an additive manufacturing system where it may be preferable to weld in the keyhole mode and transitioning to conduction mode may be indicative of an error or failure associated with a build process.

Shortwave infrared (SWIR) wavelengths of light may range from about 1000 nm to about 1700 nm, though other wavelengths associated with SWIR may be used. The emitted wavelengths of light in SWIR range may indicate temperatures associated with the melt pool, build surface, and/or other additive manufacturing process ranging from about 500° C. to about 1500° C. In some embodiments, a benefit of sensing wavelengths in the SWIR range includes that SWIR emissions are less sensitive to emissivity changes relative to wavelengths in other ranges, which may allow for easier sensing of the solid to liquid and liquid to solid transitions significantly more reliable relative to other thermal-based photosensitive detectors. Thus, in such embodiments, sensing wavelengths in the SWIR range may be used for inspection of melt pools.

The photosensitive detectors disclosed herein may correspond to any appropriate type of photosensitive detector that is configured to sense a desired type of light (e.g., ranges of wavelengths)., to sense, image, or otherwise measure processes associated with the additive manufacturing system as the disclosure is not so limited. For example, photosensitive detectors including any appropriate materials, as discussed further below, may be used. In some embodiments, multiple photosensitive detectors configured for measuring light in multiple separate ranges of wavelengths may be used. Additionally, the use of wide wavelength band photosensitive detectors configured for measuring light in multiple ranges of wavelengths as disclosed herein may be used.

As noted above, any appropriate type of photosensitive detector may be used with the methods and systems disclosed herein. In some embodiments, one or more Silicon (Si) photosensitive detectors may be used to sense at least a portion of the wavelengths of light emitted from the build surface. In some embodiments a Si photosensitive may be capable of sensing wavelengths of light ranging from about 400 nm to about 1100 nm. In some embodiments, Si photosensitive detectors may be used to sense wavelengths of light ranging from about 300 nm to about 950 nm. Accordingly, Si photosensitive detectors may be used to sense UV, plasma emission, and NIR wavelengths of light. In some embodiments, one or more Indium Gallium Arsenide (InGaAs) photosensitive detectors may be used to sense at least a portion of the wavelengths of light emitted from the build surface. InGaAs photosensitive detectors may be used to image or otherwise sense wavelengths of light ranging from about 950 nm to about 2500 nm. Accordingly, InGaAs photosensitive detectors may be used to sense NIR, laser energy, and SWIR wavelengths of light. In some embodiments, one or more photosensitive detectors including both Si and InGaAs (e.g., dual band photosensitive detectors) may be used to sense at least a portion of the wavelengths of light emitted from the build surface. Photosensitive detectors including both Si and InGaAs may allow for sensing a broader range of wavelengths of light compared to photosensitive detectors including only Si or InGaAs. Si and InGaAs photosensitive detectors may be used to image or otherwise sense wavelengths of light ranging from about 400 nm to about 2500 nm. Accordingly, Si and InGaAs photosensitive detectors may be used to sense UV, plasma emissions, laser energy, and SWIR wavelengths of light.

While specific types of photosensitive detectors are describe above, any appropriate type or combination of types of appropriate photosensitive detector may be used. For example, a photosensitive detector including Si, InGaAs, Germanium (Ge), Indium Phosphide (InP), Gallium Arsenide (GaAs), combinations of the forgoing, and/or any other appropriate type of photosensitive detector may be used. A photosensitive detector including a plurality of materials may allow for a broader range of detectable (e.g., able to be sensed) wavelengths for the photosensitive detector. Also, a photosensitive detector of any appropriate format may be used with the embodiments disclosed herein. For example, dual band, full spectrum, quadrant, array, p-i-n (e.g., PIN), any other appropriate format of photosensitive detector, and any other appropriate combination of formats thereof may be used herein.

The inventors have further recognized benefits associated with obtaining one-dimensional (1D) images or effectively 1D images for improved comparing and contrasting of melt pool regions disposed on a build surface during an additive manufacturing process relative to two-dimensional (2D) images. The 1D images may provide additional information regarding reflected light and emitted light. For many of the aforementioned sensors, there may be a tradeoff between an acquisition rate and a resolution associated with the sensors. Furthermore, the aforementioned sensors may tend to take on a 16:9 format. For both sensor specification and operation, the inventors have found it useful to utilize a 1D sensor to be able to capture melt pool changes on a timescale not achievable when using a 2D sensor having a lower associated acquisition rate. Further, the use of 1D sensing may decrease computational resources needed by the system, thereby decreasing costs overall. The use of a 2D sensor can be helpful in qualifying surrounding material around the laser during operation, allowing for determination of cause and effect on melt pool variations. The combination of the two sensing formats may allow for a further understanding of variations associated with the melt pool, motivating the need for such a in process monitoring system. In some embodiments, 2D sensors having high aspect ratios may be used to compromise between benefits and drawbacks of 1D and 2D sensors (e.g., 2048×128 pixel arrays). This may be particularly useful when observing 1D laser pixel arrays.

As previously described, different emissions occur during a build process. The emissions compose a wide range of wavelengths, with different ranges of the wavelengths providing different information about various aspects of the build process. Imaging or otherwise sensing the different ranges of wavelengths simultaneously may permit monitoring of different aspects of the build process simultaneously. Simultaneously monitoring different aspects of the build process may serve to reduce the time and burden associated with monitoring the build process in addition to other potential benefits. However, instances in which the disclosed methods and system are used to monitor a single range of wavelengths are also contemplated as the disclosure is not so limited.

Separately, the systems and methods disclosed herein may be used to enable real-time monitoring of a build process with a greater resolution as well as fewer registration and calibration steps needed to provide the desired monitoring as compared to other typical monitoring systems. That is, the detectors as described herein may sense information associated with the build process while a part is being built. Monitoring the build process in real-time may allow for controlling of one or more processes of the additive manufacturing system. This may be done to maintain a build process within a desired range of operating parameters and/or in an attempt to correct sensed errors and/or defects associated with the build process. In some instances, the sensed parameters may indicate the presence of a defective part that cannot be repaired, in which case, the system may be controlled to stop building these defective parts. The benefits resulting from real-time monitoring may help to reduce cost and save time by avoiding wasted material and more efficiently utilizing the additive manufacturing system. In instances where the photosensitive detectors are translated across a build surface in sync with a optics assembly of the system, the resulting composite field of view of the one or more photosensitive detectors may provide a larger effective field of view of the one or more detectors which may correspond to substantially the entire active portion of a build surface on which one or more parts are being built.

As described herein, in some embodiments a single photosensitive detector may be used to sense a broad range of wavelengths. The benefits of using a single photosensitive detector may include reduced cost, simplified software and/or programming architectures, simplified optics assemblies (e.g., less optical paths and associated optical components), simultaneous capture to reduce synchronization, and other benefits. However, as noted previously, embodiments including multiple photosensitive detectors are also contemplated.

As used herein, a beam splitter may refer to an optical device that is configured to split a path of light into a transmitted path with desired power and spectral characteristics and a reflected path with desired power and spectral characteristics. In other words, a beam splitter splits light into a transmitted portion and a reflected portion of the incident light. The transmitted portion and the reflected portion may be directed along different optical paths. Any beam splitter may be used herein, including cube beam splitters, half-silvered mirrors, dichroic mirrors, any other appropriate beam splitter, and any combination thereof. In some embodiments, a beam splitter is a dichroic mirror (e.g., dual-band mirror, dual-wavelength mirror, or dichroic reflector) or other appropriate beam splitter that includes a cutoff wavelength. For example, a dichroic mirror may include a wavelength threshold (e.g., cutoff) wherein wavelengths below the threshold behave differently than wavelengths above the threshold when incident on the dichroic mirror. In some embodiments, a dichroic mirror may reflect a first group of wavelengths of light above the threshold wavelength and may transmit a second group of wavelengths of light below the threshold wavelength.

To diffract light as described herein, one or more diffractive optical elements may be used. A diffractive optical element may refer to any optical element, component, or feature that diffracts light that is directed into the diffractive optical element into a range of different wavelengths (e.g., a continuous spectrum of wavelengths) and profiles (e.g., top hat, spot array) that are emitted from the diffractive optical element. Examples of diffractive optical elements may include, but are not limited to, diffraction gratings, prisms, apertures configured to diffract the incident light, diffractive diffusers, diffractive pattern generators, diffractive beam splitters, diffractive beam shapers, combinations of the above, and/or any appropriate type of optics capable of diffracting the incident light.

The additive manufacturing systems described herein may weld (e.g., fuse) material in any appropriate welding mode or combination of welding modes. In some embodiments, material may be fused using conduction mode welding. Conduction mode welding may be achieved using lower laser energy and may result in a shallower and wider welds relative to other welding modes. Conduction mode welding may result in a higher amount of reflected laser energy and associated wavelengths relative to other welding modes. In some embodiments, material may be fused using keyhole mode welding. Keyhole mode welding may penetrate deeper into the build surface and cause vaporization of the material being welded, resulting in a deeper and narrower weld relative to other modes of welding. Keyhole mode welding may result in a lower amount of distortion in a part being built relative to other modes of welding. Accordingly, in some embodiments it may be preferable to fuse precursor material disposed on the build surface using keyhole mode welding. Keyhole mode welding may result in the material being fused absorbing a higher amount of laser energy and accordingly reflecting less laser energy and associated wavelengths relative to other welding modes. In some embodiments, an overall stability of a build process understood at least in part by determining the mode of welding. For example, keyhole mode welding may be desired throughout the entire build process and as such sensing that the current mode of welding as conduction may indicate a lack of stability in the system. Accordingly, sensing the current mode of welding as keyhole mode welding may indicate stability within the system.

The systems and methods disclosed herein may be applied to any manufacturing process that utilize an energy source (e.g., laser beam) that may be monitored. Examples include any appropriate powder bed fusion process such as direct metal laser sintering, electron beam melting, selective heat sintering, selective laser melting, and selective laser sintering. Additionally, any process or system that results in emitted wavelengths of light that may be monitored to improve process quality may use the systems and methods disclosed herein. This may be especially useful in cases where relatively broad ranges of wavelengths of light are of interest. For example, any appropriate laser cutting, welding, laser cleaning, laser marking, or any other manufacturing process may use the systems and methods disclosed herein.

In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources), which may also be referred to as an intensity herein in some instances, may be between about 50 W and about 2,000 W (2 kW). For example, the power output for each laser energy source may be between about 100 W and about 1.5 KW, and/or between about 500 W and about 1 kW. Moreover, a total power output of the plurality of laser energy sources may be between about 500 W (0.5 kW) and about 4,000 kW. For example, the total power output may be between about 1 kW and about 2,000 kW, and/or between about 100 KW and about 1,000 kW. Ranges both greater and less than those noted above are also contemplated as the disclosure is not so limited.

Depending on the embodiment, an array of laser energy pixels (e.g., a line array or a two dimensional array) may have a uniform power density along one or more axes of the array including, for example, along the length dimension (i.e. the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber is greater than or equal to 0.1 W/micrometer², greater than or equal to 0.2 W/micrometer², greater than or equal to 0.5 W/micrometer², greater than or equal to 1 W/micrometer², greater than or equal to 1.5 W/micrometer², greater than or equal to 2 W/micrometer², or greater. In some embodiments, the power area density of the laser energy transmitted through the optical fiber is less than or equal to 3 W/micrometer², less than or equal to 2 W/micrometer², less than or equal to 1.5 W/micrometer², less than or equal to 1 W/micrometer², less than or equal to 0.5 W/micrometer², less than or equal to 0.2 W/micrometer², or less. Combinations of these ranges are possible. For example, in some embodiments, the power area density of the laser energy transmitted through the optical fiber is greater than or equal to 0.1 W/micrometer² and less than or equal to 3 W/micrometer².

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

Also, emitting wavelengths of light from a build surface as mentioned herein may include emitted wavelengths of light from the build surface (e.g., due to a change in the build surface resulting from an elevated temperature) as well as reflected wavelengths of light. In other words, emitting wavelengths of light may include reflecting wavelengths of light.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

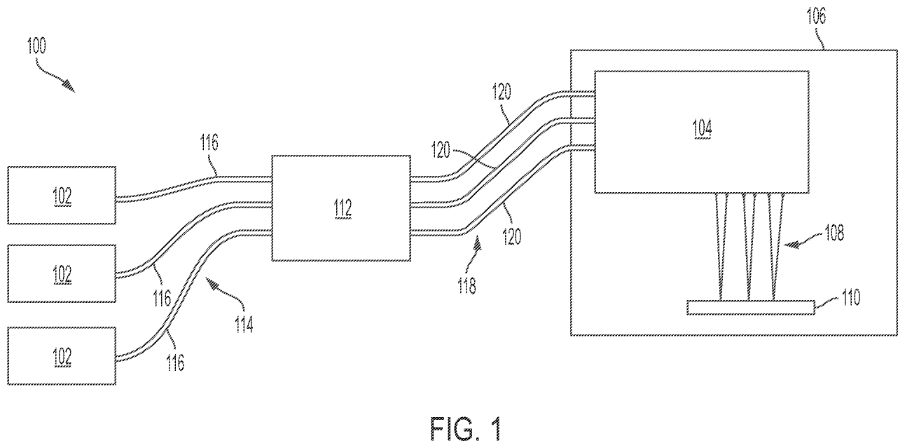

FIG. 1 shows, according to some embodiments, a schematic representation of an additive manufacturing system 100, including a plurality of laser energy sources 102 that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the one or more laser energy sources 102 and the optics assembly 104. As illustrated, a first plurality of optical fibers 114 may extend between the plurality of laser energy sources 102 and the optical fiber connector 112. In particular, each laser energy source 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Of course other methods of connecting the one or more laser energy sources 100 due to the optics assembly 104 are also contemplated.

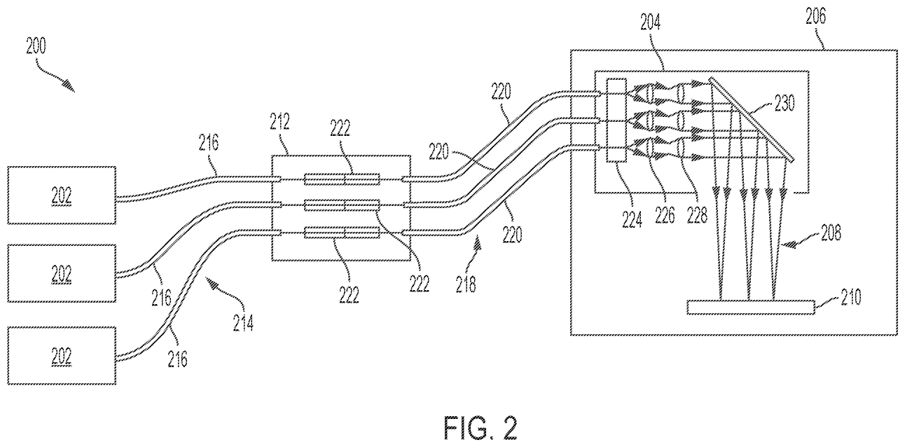

FIG. 2 shows a schematic representation of another embodiment of an additive manufacturing system 200. Similar to the embodiment discussed above in connection with FIG. 1, the additive manufacturing system 200 includes a plurality of laser energy sources 202 coupled to the optics assembly 204 within the machine enclosure 206 via the optical fiber connector 212. The first plurality of optical fibers 214 extends between the one or more laser energy sources 202 and the optical fiber connector 212, and the second plurality of optical fibers 218 extends between the optical fiber connector 212 and optics assembly 204. In particular, each optical fiber 216 of the first plurality of optical fibers is coupled to a laser energy source 202 and corresponding optical fiber 220 of the second plurality of optical fibers 218. In the depicted embodiment, optical fibers 216 are coupled to corresponding optical fibers 220 via fusion splices 222 within the optical fiber connector 212. However, embodiments, in which the optical fibers positioned within the connector are optically coupled using other types of connections and/or single continuous optical fibers are used are also envisioned.

In the depicted embodiment, the optical fibers 220 of the second plurality of optical fibers 218 are optically coupled to an optics assembly 204 of the system. For example, an alignment fixture 224 is configured to define a desired spatial distribution of the optical fibers used to direct laser energy into the optics assembly. For example, the alignment fixture may comprise a block having a plurality of v-grooves or holes in which the optical fibers may be positioned and coupled to in order to accurately position the optical fibers within the system.

FIG. 2 also depicts exemplary optics that are optically coupled to and positioned downstream from the second plurality of optical fibers 218. The various optics included in the optics assembly may be configured to direct laser energy 208 from the second plurality of optical fibers 218 on the build surface 210 to form a desired array pattern of laser energy pixels on the build surface. For example, the optics assembly may include beam forming optics such as lenses 226 and 228 (which may be individual lenses, lens arrays, and/or combined macrolenses), mirrors 230, and/or any other appropriate type of optics disposed along the various optical paths between the optical fibers and the build surface 210 which may shape and direct the laser energy within the optics assembly. Once appropriately sized and shaped, the laser energy 208 may be directed onto the build surface 210 either through direct transmission and/or using a light directing element such as the depicted mirror 230.

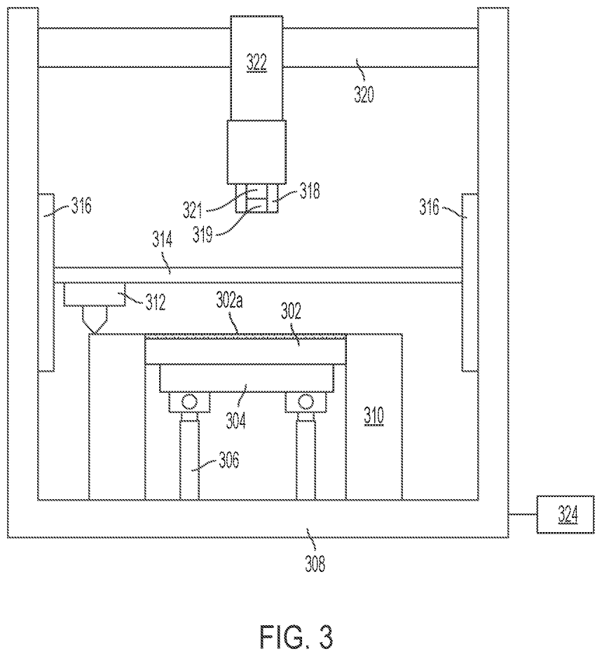

FIG. 3 depicts one embodiment of an additive manufacturing system at the beginning of a build process. The additive manufacturing system includes a build plate 302 mounted on a fixed plate 304, which is in turn mounted on one or more vertical supports 306 that attach to a base 308 of the additive manufacturing system. In the depicted embodiment, the one or more vertical supports may correspond to one, two, and/or any other appropriate number of supports configured to support the build plate, and the corresponding build surface, at a desired position and orientation. For example, the supports depicted in the figure may correspond to one or more vertical motion stages configured to control a vertical position and orientation of the build plate. A powder containment shroud 310 may at least partially, and in some embodiments completely, surround a perimeter of the build plate 302 to support a volume of precursor material 302a, such as a volume of powder, disposed on the build plate and contained within the shroud. The shroud may be supported on the base 308 or by any other appropriate portion of the system.

The additive manufacturing system may include a powder deposition system in the form of a recoater 312 that is mounted on a horizontal motion stage 314 that allows the recoater to be moved back and forth across either a portion, or entire, surface of the build plate 302. As the recoater traversers the build surface of the build plate, it deposits a precursor material 302a, such as a powder, onto the build plate and smooths the surface to provide a layer of precursor material with a predetermined thickness on top of the underlying volume of fused and/or unfused precursor material deposited during prior formation steps.

In some embodiments, the supports 306 of the build plate 302 may be used to index the build surface of the build plate 302 in a vertical downwards direction relative to a local direction of gravity. In such an embodiment, the recoater 312 may be held vertically stationary for dispensing precursor material 302a, such as a precursor powder, onto the exposed build surface of the build plate as the recoater is moved across the build plate each time the build plate is indexed downwards.

In some embodiments, the additive manufacturing system may also include an optics assembly 318 that is supported vertically above and oriented towards the build plate 302. As detailed above, the optics assembly may be optically coupled to one or more laser energy sources, not depicted, to direct laser energy in the form or one or more laser energy pixels onto the build surface of the build plate 302. The optics assembly may also include one or more photosensitive detectors 321 and corresponding optics 319 (e.g., beam splitters and/or diffractive optical elements) described herein to sense wavelengths emitted from the build surface and/or to monitor laser energy. To facilitate movement of the laser energy pixels across the build surface, the optics assembly may be configured to move in one, two, or any number of directions in a plane parallel to the build surface of the build plate. To provide this functionality, the optics assembly may be mounted on a gantry 320, or other actuated structure, that allows the optics unit to be scanned in plane parallel to the build surface of the build plate. In some embodiments, the one or more photosensitive detectors 321 and corresponding optics 319 may be coupled to and move in sync with the optics assembly 318 as it is translated relative to the build surface and build plate 302 as shown in the FIG. 3. However, embodiments, in which the one or more photosensitive detectors 321 and corresponding optics 319 are mounted on a separately controlled gantry, arm, or other moveable structure for scanning across a surface are also contemplated. Further, while a majority of the embodiments disclosed herein are directed to sensing systems that are scanned across a surface, embodiments in which one or more stationary photosensitive detectors are used are also contemplated.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system may also include an optics assembly 318 that is supported on a vertical motion stage 320 that is in turn mounted on the gantry 320 that allows the optics unit to be scanned in the plane of the build plate 302.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

In addition to the above, in some embodiments, the depicted additive manufacturing system may include one or more controllers 324 that is operatively coupled to the various actively controlled components of the additive manufacturing system. For example, the one or more controllers may be operatively coupled to the one or more supports 306, recoater 312, optics assembly 318, the various motion stages, and/or any other appropriate component of the system. In some embodiments, the controller may include one or more processors and associated non-transitory computer readable memory. The non-transitory computer readable memory may include processor executable instructions that when executed by the one or more processors cause the additive manufacturing system to perform any of the methods disclosed herein.

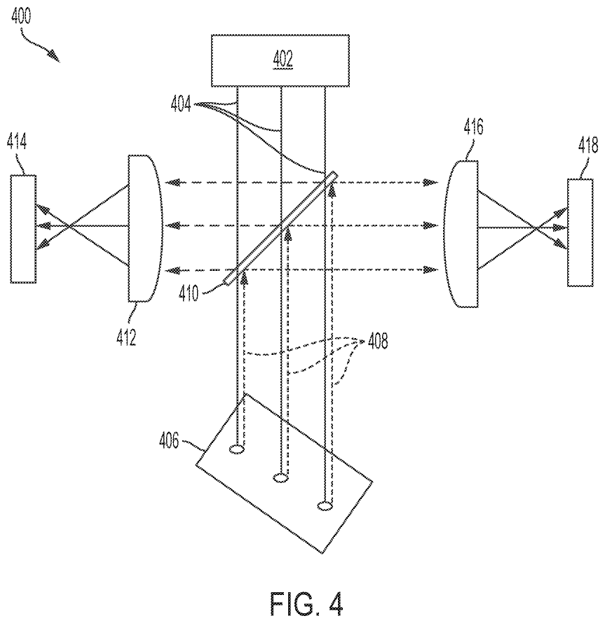

Monitoring laser energy prior to being incident on a build surface of an additive manufacturing system may provide benefits as described previously, including controlling laser energy sources based at least in part on the monitored laser energy. In some embodiments, such as the depicted embodiment of FIG. 4, laser energy prior to being incident on a build surface may be monitored alone or in combination with wavelengths of light that may be emitted from the build surface. Accordingly, FIG. 4 shows a monitoring system 400 for an additive manufacturing system according to some embodiments. As shown, one or more laser energy sources 402 may direct laser energy 404 towards a build surface 406 (e.g., in the form of one or more laser energy pixels). In some embodiments, the laser energy 404 may be incident on a first beam splitter 410 (e.g., a dichroic mirror) disposed upstream from the build surface along an optical path extending between the build surface and the one or more laser energy sources. In some embodiments, a first photosensitive detector 414 may be coupled to a first optical path and a second photosensitive detector 418 may be coupled to a second optical path. The first beam splitter 410 may direct at least a portion of the laser energy towards the first photosensitive detector 414 and a first optics 412. In some embodiments, the first optics 412 may direct the laser energy onto a first photosensitive detector 414. The photosensitive detector 414 may image, sense, or otherwise detect the incident laser energy. Upon being incident on the build surface 406, the laser energy 404 may be at least partially absorbed by the precursor material to heat and fuse the precursor material. In addition to heating the precursor material, the resulting melt pools may also emit light 408 from the build surface 406 due to reflection, high temperature emission, and/or other appropriate sources of light emission.

One or more parameters related to the laser energy may be sensed by the first photosensitive detector 414 from the portion of laser energy directed towards the first photosensitive detector 414. In some embodiments, one or more processors connected to the first photosensitive detector 414 may receive signals from the first photosensitive detector 414 and may be configured to determine one or more parameters of the laser energy based at least in part on the sensed portion of the laser energy. In some embodiments, the one or more parameters of the laser energy may include one or more of intensity, intensity per unit area, shape, size, temporal profile, and any other appropriate parameter. Monitoring the laser energy parameters may include comparing one or more laser energy parameters to a reference power, reference power profile, or other appropriate reference parameter. In some embodiments, a difference between at least one parameter and at least one reference parameter of the one or more reference parameters may be determined. In further embodiments, a user may be alerted if a difference between the sensed laser energy and the reference power and/or reference power profile is greater than a threshold difference. The threshold difference between the laser energy and the reference power profile may relate to a shape and an intensity of the reference power profile in some embodiments. In some embodiments, an alert may be output and/or the additive manufacturing process may be controlled based at least in part on the determined parameter if the difference is greater than a threshold difference.

It may also be desirable to monitor emitted light 408 from the build surface 406 in some instances. In such an embodiment, the wavelengths of light 408 emitted from the build surface 406 may be directed to a second photosensitive detector 418 which may be configured to sense the emitted light 408. In the depicted embodiment, the emitted light 408 is directed back along the path of the laser energy beams such that the emitted light is directed towards the first beam splitter 410. The first beam splitter 410 may then direct at least a portion of the emitted light 408 towards the second photosensitive detector 418. The emitted wavelengths of light may be directed onto the second photosensitive detector 418 via a second optics 416. Depending on the embodiment, the redirected emitted light from the first beam splitter 410 may either be the same range of wavelengths as directed to the first photosensitive detector 414, or they may be a different range of wavelengths as the disclosure is not so limited.

In the depicted embodiment, three beams (e.g., paths) of laser energy are emitted from the laser energy source, however, it should be appreciated that any number beams of laser energy may be emitted from the laser energy source. In the depicted embodiment the optics may include one or more of a beam shaping lens (e.g., collimator), beam splitters, diffractive optical elements, diffusers, photosensitive detectors (e.g., 1D or 2D), photodiodes, attenuators, filters, dichroic, combinations of the forgoing, and/or any other appropriate optical element.

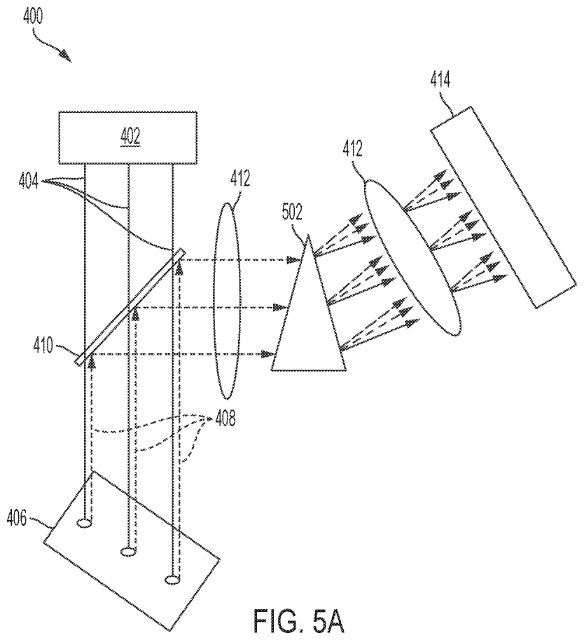

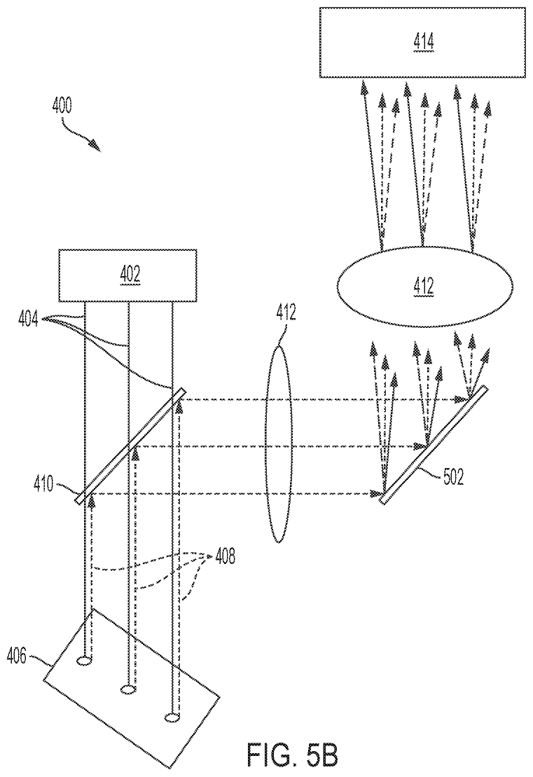

As noted previously, it may be desirable to monitor multiple ranges of wavelengths with different portions (e.g., separate groups of pixels) of a photosensitive detector. Simultaneously monitoring multiple ranges of wavelengths of light emitted from a build surface with a photosensitive detector during an additive manufacturing build process may offer multiple benefits as noted previously above. FIGS. 5A and 5B show one embodiment of a monitoring system 400 of an additive manufacturing or other appropriate system including a diffractive optical element 502 according to some embodiments. Similar to the above, one or more laser energy sources 402 may direct laser energy 404 onto a build surface 406. A portion of the laser energy may optionally be directed along one or more optical paths for imaging and/or monitoring as previously described. This may include, in some embodiments, directing at least a portion of wavelengths of light 408 emitted from the build surface 406 towards a photosensitive detector 414 along an optical path that is at least partly non-contiguous with the optical path extending between the one or more laser energy sources 402 and the build surface 406.

Specifically, as shown in the embodiment of FIG. 5A, a beam splitter 410 may direct emitted light from the build surface 406 towards a diffractive optical element 502. One or more optics 412 may be disposed between at least one of the beam splitter 410 and the build surface 406 and may be configured to direct the emitted light to the diffractive optical element 502. The diffractive optical element 502 may be disposed between the build surface and the photosensitive detector 414. In some embodiments, the diffractive optical element 502 may be disposed between the beam splitter 410 and the photosensitive detector 414. The diffractive optical element 502 may be configured to diffract the emitted light into a range of separate wavelengths of light. The diffractive optical element 502 may also be configured to direct the range of separate wavelengths of light towards the photosensitive detector 414. Additionally, one or more optics 412 may be disposed between the diffractive optical element 502 and the photosensitive detector 414 and may be configured to direct the range of separate wavelengths of light to the photosensitive detector 414. In the embodiment depicted by FIG. 5A, the diffractive optical element is a prism. FIG. 5B depicts an embodiment that is similar to FIG. 5A and includes a diffraction grating as the diffractive optical element 502 in place of the prism of FIG. 5A. As previously discussed, the embodiments depicted in FIGS. 5A and 5B are merely example embodiments and the disclosure is not limited to these embodiments. For example, the diffractive optical element 502 in FIG. 5A and/or 5B may be replaced with any other appropriate diffractive optical element including but not limited to one or more apertures configured to diffract the emitted light and/or any appropriate range of wavelengths of light.

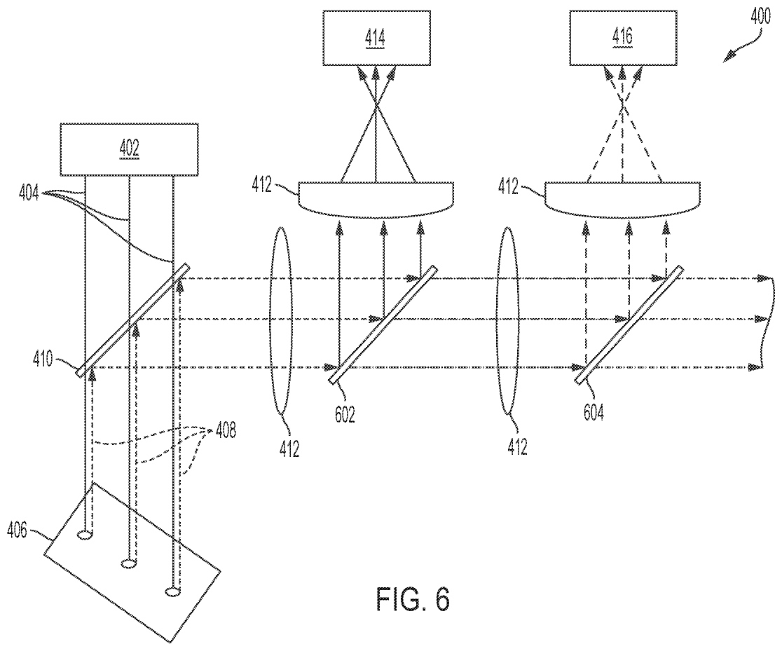

As mentioned elsewhere, embodiments such as the depicted embodiments of FIGS. 5A, 5B, and 6 may include one or more beam splitters in any appropriate location along an optical path. For example, a beam splitter may be disposed between the build surface 406 and the diffractive optical element 502, and may be configured to split the emitted light into a first range of wavelengths of light and a second range of wavelengths of light. The beam splitter may be configured to direct the first range of wavelengths of light to the diffractive optical element 502 according to some embodiments. Of course, the beam splitter may also direct the second range of wavelengths of light to one or more separate diffractive optical elements 502 as the disclosure is not so limited. In some embodiments, the beam splitter may direct the first range of wavelengths of light or the second range of wavelengths of light to one or more photosensitive detectors. In embodiments having multiple beam splitters, a diffractive optical element 502 may be disposed before or after any beam splitter in the monitoring system 400. For example, a diffractive optical element 502 may be disposed after a third beam splitter 604 and may be configured to diffract a fourth range of wavelengths of light into a range of separate wavelengths. Embodiments which employ one or more beam splitters as well as one or more diffractive optical elements may monitor wavelengths associated with the build process using both the split ranges of wavelengths and the diffracted ranges of wavelengths. Such an embodiment may have benefits from both the split ranges and the diffracted ranges as described herein.

In some embodiments, a diffractive optical element 502 may diffract the emitted wavelengths of light. One or more optics 412 may be used to filter, focus, direct, collimate, or otherwise manipulate the emitted wavelengths of light 408 along one or more optical paths. The optics 412 may be disposed in any appropriate location. For example, the optics 412 may be disposed between the first beam splitter and at the first photosensitive detector 414. The diffracted wavelengths may be directed onto a photosensitive detector 414 and the photosensitive detector may sense the separate wavelengths of light. In some embodiments, separate portions of the photosensitive detector 414 may sense the separate ranges of wavelengths of light. The separate portions may include separate groups of pixels associated with the photosensitive detector configured to sense the separate ranges of wavelengths of light.

The separate groups of pixels disposed on a photosensitive detector may be of any appropriate arrangement and/or configuration as the disclosure is not so limited. Additionally, a photosensitive detector may include any appropriate quantity of groups of pixels as the disclosure is also not limited in this fashion. In some embodiments, a photosensitive detector may include a singular group of pixels formed as a row of pixels. In further embodiments, a photosensitive detector may include a plurality of groups of pixels, wherein the groups of pixels are formed as one or more rows of pixels where a desired range of wavelengths are incident on the separate groups of pixel rows. However, it should be understood that a group of pixels may be formed by any appropriate combination of contiguous pixels. For example, a group of pixels may be formed by contiguous pixels forming a substantially square shape or any other appropriate shape or pattern of any appropriate size (e.g., any appropriate number of pixels). Further, a group of pixels formed as a row may comprise any appropriate length and width defined by a number of pixels (e.g., one or more pixels).

According to some embodiments, a group of pixels may only have a singular pixel. In this case, a row of groups of pixels, where each group of pixels is a singular pixel, may form a one-dimensional (1D) image. The benefits associated with obtaining a 1D image are described previously. In some embodiments, obtaining a 1D image may involve using a first optical element to direct reflected light and emitted light from a melt pool disposed on the build surface onto a second optical element, wherein the second optical element may separate the desired wavelengths along an axis (e.g., vertical axis) of the image. In some embodiments, either the first optical element or the second optical element may be a diffractive optical element as described herein. This may effectively convert a standard image from a 2D photosensitive detector into a series of 1D spectrometer lines allowing for simultaneous imaging of different wavelengths of light. In some embodiments, a 1D photosensitive detector (e.g., line camera) comprising a one-dimensional array of pixels may be used herein.

In embodiments where emitted light or a range of wavelengths are diffracted to form a continuous range of wavelengths. Thus, the diffracted light may form a plurality of substantially parallel lines of light on a photosensitive detector the light is incident on where the different parallel lines may have different ranges of wavelengths contained within. Accordingly, in some embodiments one or more groups of pixels (e.g., rows) extending in a direction parallel to the parallel lines of different ranges of wavelength of light may be configured to sense the different ranges of wavelengths incident on these different groups of pixels (e.g., groups of one or more rows of pixels). For example, a first range of wavelengths may be incident on a first group of one or more rows of pixels and a second range of wavelengths, different from the first range, may be incident on a second group of one or more rows of pixels adjacent to the first row of pixels. In the depicted embodiment of FIG. 5A, the diffractive optical element is a prism. In the depicted embodiment of FIG. 5B, the diffractive optical element 502 is a grating surface. The use of an optical grating (e.g., using a grating surface to diffract) may enable improved control over ranges and the direction of angles of wavelengths of light being diffracted relative to a prism. For example, diffracted wavelengths of light from a prism may be directed at an angle, potentially resulting in necessarily more complicated optical paths to properly direct the wavelengths of light. In contrast, optical grating may allow for orthogonal diffraction of wavelengths of light, reducing the angles used to direct the wavelengths of light and correspondingly reducing the complexity of associated optical paths. In some embodiments, a prism may enable frequency dispersion over a wider frequency relative to a grating surface.

As previously mentioned, any appropriate 1D or 2D photosensitive detector comprising a one-dimensional or two dimensional array of pixels, respectively, may be used to sense the diffracted or split wavelengths of light. Additionally, any appropriate photosensitive detector mentioned herein may comprise a one-dimensional or two-dimensional array of pixels. Also previously mentioned, the separate wavelengths of light may be sensed using a single photosensitive detector or a plurality of separate photosensitive detectors. The range of separate wavelengths of light that may be sensed may include a first range of wavelengths of light between about 400 nanometers to 600 nanometers, a second range of wavelengths of light between about 800 nanometers to 1000 nanometers, a third range of wavelengths of light between about 1050 nanometers to about 1100 nanometers, a fourth range of wavelengths of light between about 1500 nanometers to about 1700 nanometers, combinations of the above, and/or any other appropriate range of wavelengths. In some embodiments, a first group of pixels of one or more photosensitive detectors may be configured to sense the first range of wavelengths of light, a second group of pixels of the one or more photosensitive detectors may be configured to sense the second range of wavelengths of light, a third group of pixels of the one or more photosensitive detectors may be configured to sense the third range of wavelengths of light, and a fourth group of pixels of the one or more photosensitive detectors may be configured to sense the fourth range of wavelengths of light. It should be understood that the present disclosure is not limited to sensing any particular range of wavelengths or combination of ranges of wavelengths of light.

In some embodiments, the monitoring system 400 may include more than one photosensitive detector configured to sense wavelengths emitted from the build surface. In the depicted embodiment of FIG. 6, a first photosensitive detector 414 may sense a first range of wavelengths of light and a second photosensitive detector 416 may sense a second range of wavelengths of light. The depicted embodiment shows two photosensitive detectors; however, any appropriate number of photosensitive detectors may be used. The emitted wavelengths of light 408 may be directed to a first beam splitter 410, which may reflect or otherwise direct the emitted wavelengths of light onto a second beam splitter 602. The second beam splitter 602 may be disposed between at least one of the build surface and the first beam splitter 410 and the first photosensitive detector 414. The second beam splitter 602 may also be disposed between at least one of the build surface and the first beam splitter 410 and a third beam splitter 604. The second beam splitter 602 may direct a first range of wavelengths of light towards a first photosensitive detector 414 and direct a second range of wavelengths of light to the third beam splitter 604. The first photosensitive detector 414 may terminate at the end of an optical path, where the optical path may include any appropriate optical elements as described herein.

The third beam splitter 604 may be disposed between at least one of the second beam splitter 602, first beam splitter 410, and build surface 406 and the second photosensitive detector 416. Additionally, the third beam splitter 604 may be disposed between at least one of the second beam splitter 602, first beam splitter 410, and build surface 406 and any proceeding beam splitters (e.g., a third beam splitter, and/or a fourth beam splitter), photosensitive detectors (e.g., a third photosensitive detector, and/or a fourth photosensitive detector), optics, any other proceeding element, and any combination thereof which may be located in downstream beyond the curved line shown in the depicted embodiment of FIG. 6. The third beam splitter 604 may split the second range of wavelengths of light into a third range of wavelengths of light and a fourth range of wavelengths of light and may direct the third range of wavelengths of light towards a second photosensitive detector 416. The second photosensitive detector 416 may terminate at the end of an other optical path, where the other optical path may include any appropriate optical elements as described herein. Accordingly, the second photosensitive detector may sense the third range of wavelengths of light. The fourth range of wavelengths of light may be directed to a fourth beam splitter, a third photosensitive detector (which may sense the fourth range of wavelengths of light), or any appropriate optical element. The fourth range of wavelengths may be successively split into increasingly narrower ranges of wavelengths of light any appropriate number of time and the increasingly narrower ranges of wavelengths may be sensed as desired. To represent optional further splitting and sensing, the three arrows representing the fourth range of wavelengths are shown as being directed to a curved line in FIG. 6. For clarity, the fourth range of wavelengths may be directed to any appropriate element, not shown, in the direction of the curved line.

In embodiments including more than one photosensitive detector, emitted wavelengths may be directed to optics (e.g., any appropriate filter, diffractive optical element, beam splitter, any other appropriate optical clement, and any combination thereof). The optics may be disposed in any appropriate location. For example, the optics may be disposed between the first beam splitter 410 and at least one of the first photosensitive detector 414 and the second photosensitive detector 416. Further, one or more filters may be configured to filter emitted light from the build surface in any of the embodiments disclosed herein.

Similar to the other embodiments described herein, the optics 412 shown in FIG. 6 may be any appropriate optical element including beam shaping lens (e.g., collimator), beam splitters, diffractive optical elements, diffusers, photosensitive detectors (e.g., 1D or 2D), photodiodes, attenuators, filters, dichroic, combinations of the forgoing, and/or any other appropriate optical element. In some embodiments, one or more of the optics 412 may include a collimating lens to focus wavelengths onto one or more of the photosensitive detectors shown in FIG. 6. Optics 412 may be disposed in any appropriate locations. For example, optics 412 may be disposed between the first beam splitter and at least one of the first photosensitive detector 414 and the second photosensitive detector. Optics 412 may also be disposed between the second beam splitter 602 and the third beam splitter 604, between the second beam splitter 602 and the first photosensitive detector 414, between the third beam splitter 604 and the second photosensitive detector 416, and/or any other appropriate location in the monitoring system 400.

In the depicted embodiment of FIG. 6, one or more laser energy sources 402 may direct laser energy 404 towards a build surface 406. The laser energy 404 may interact with the build surface as described herein such that light 408 is emitted from the build surface 406. The emitted light 408 may travel (or be directed) along an optical path to the first beam splitter 410. The fist beam splitter 410 may direct the emitted light 408 towards a second beam splitter 602. Optics 412 disposed between the first beam splitter 410 and the second beam splitter 602 may help to direct the emitted light 408 to the second beam splitter 602. The second beam splitter 602 may split the emitted light 408 into a first range of wavelengths of light and a second range of wavelengths of light. The second beam splitter 602 may direct the first range of wavelengths of light towards a first photosensitive detector 414. Optics 412 disposed between the second beam splitter 602 and the first photosensitive detector 414 may help to direct the first range of wavelengths of light towards the first photosensitive detector 414. The second beam splitter 602 may direct the second range of wavelengths of light towards a third beam splitter 604. Optics 412 disposed between the second beam splitter 602 and the third beam splitter 604 may help to direct the second range of wavelengths of light towards the third beam splitter 604.

The third beam splitter 604 may split the second range of wavelengths of light into a third range of wavelengths of light and a fourth range of wavelengths of light. The third beam splitter may direct the third range of wavelengths of light towards a second photosensitive detector 416. Optics 412 disposed between the third beam splitter 604 and the second photosensitive detector 416 may help to direct the third range of wavelengths of light towards the second photosensitive detector 416. The third beam splitter 604 may direct the fourth range of wavelengths of light toward any proceeding optical element or combination of optical elements as described herein and as indicated by the curved line in the depicted embodiment of FIG. 6.

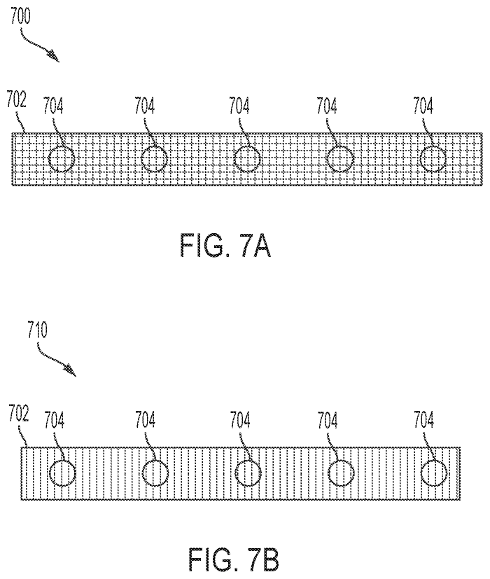

FIGS. 7A and 7B show images of melt pools 704 which may be disposed on a build surface according to some embodiments. The image shown in FIG. 7A includes a two-dimensional array of pixels according to some embodiments. The image shown in FIG. 7B includes a one-dimensional array of pixels according to some embodiments. As previously described obtaining an image of melt pools may provide information associated with the melt pools during the build process. Information associated with the melt pools may include measurements associated with a melt pool including a width, length, diameter, circumference, area, or any other appropriate dimensions associated with a weld track. Images may also include information regarding thermal signatures and temperature. In some embodiments, an image including a melt pool may be used to help to determine if a fusion event occurred. For example, the image may include information indicating a lack of fusion between one or more layers of a part. In some embodiments, different photosensitive detectors may be used for different purposes. For example, a first photosensitive detector may be used to determine one or more dimensions associated with a melt pool by sensing one range of wavelengths and a second photosensitive detector may be used to determine temperature associated with the melt pool by sensing another range of wavelengths. As previously mentioned, the images may be taken during the build process (e.g., in real-time).

In some embodiments, sensing the same ranges of wavelengths may indicate different information depending on what precursor material is being used. For example, sensing a certain range of wavelengths while a first material is being fused may indicate proper fusion while sensing the same certain range of wavelengths for a second material being fused may indicate improper fusion.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method for monitoring an additive manufacturing process, the method comprising:
directing laser energy from one or more laser energy sources onto a build surface;
emitting and/or reflecting light from the build surface including a plurality of wavelengths of light;
splitting the emitted light into at least a first range of wavelengths of light and a second range of wavelengths of light different from the first range of wavelengths of light;
sensing the first range of wavelengths of light with a first photosensitive detector; and
sensing the second range of wavelengths of light with a second photosensitive detector.

2. The method of claim 1, wherein splitting the emitted light includes directing the emitted light through one or more beam splitters.

3. The method of claim 2, further comprising filtering the emitted light using one or more filters selected from a group of notch filters, low pass filters, and high pass filters, wherein the one or more filters are disposed between at least one of the one or more beam splitter and at least one of the first photosensitive detector and the second photosensitive detector.

4. The method of claim 2, wherein the one or more beam splitters are dichroic mirrors that are at least partially reflective and reflect at least a portion of the wavelengths of light towards at least one of the first photosensitive detector and the second photosensitive detector.

5. The method of claim 1, further comprising diffracting at least one of the first range of wavelengths of light and the second range of wavelengths of light into a range of separate wavelengths of light and sensing the range of separate wavelengths of light on separate portions of the first photosensitive detector and/or on separate portions of the second photosensitive detector.

6. The method of claim 5, wherein splitting the emitted light includes directing the emitted light into at least a first beam splitter and wherein the diffractive optical element is disposed between the first beam splitter and at least one of the first photosensitive detector and the second photosensitive detector.

7. The method of claim 1, wherein the first range of wavelengths of light is between about 400 nanometers to 600 nanometers and the second range of wavelengths of light is between about 800 nanometers to 1000 nanometers.

8. The method of claim 1, wherein splitting the emitted light includes splitting the emitted light into a third range of wavelengths of light, and further comprising sensing the third range of wavelengths of light using a third photosensitive detector.

9. The method of claim 8, wherein splitting the emitted light includes splitting the emitted light into a fourth range of wavelengths of light, and further comprising sensing the fourth range of wavelengths of light using the third photosensitive detector.

10. The method of claim 9, wherein the third range of wavelengths of light is between about 1050 nanometers to about 1100 nanometers and the fourth range of wavelengths of light is between about 1500 nanometers to about 1700 nanometers.

11. The method of claim 1, wherein the first photosensitive detector and the second photosensitive detector comprise a one-dimensional array of pixels.

12. The method of claim 1, further comprising fusing precursor material disposed on the build surface with the laser energy to form one or more parts on the build surface.

13. A part manufactured using the method of claim 1.

14. An additive manufacturing system comprising:
a build surface;
one or more laser energy sources configured to direct laser energy onto the build surface, wherein light is emitted from the build surface including a plurality of wavelengths upon exposure to the laser energy;
a first beam splitter configured to split the emitted light into at least a first range of wavelengths of light and a second range of wavelengths of light different from the first range of wavelengths of light;
a first photosensitive detector coupled to the first beam splitter, wherein the first photosensitive detector is configured to sense the first range of wavelengths of light; and
a second photosensitive detector coupled to the first beam splitter, wherein the second photosensitive detector is configured to sense the second range of wavelengths of light.

15. The additive manufacturing system of claim 14, further comprising one or more filters selected from a group of notch filters, low pass filters, and high pass filters, wherein the one or more filters are disposed between the first beam splitter and at least one of the first photosensitive detector and the second photosensitive detector.

16. The additive manufacturing system of claim 14, wherein the first beam splitter is a dichroic mirror.

17. The additive manufacturing system of claim 14, further comprising a diffractive optical element disposed between the first beam splitter the first photosensitive detector, wherein the diffractive optical element is configured to diffract the first range of wavelengths of light into a range of separate wavelengths of light, and wherein separate groups of pixels of the first photosensitive detector are configured to sense the range of separate wavelengths of light.

18. The additive manufacturing system of claim 17, wherein the diffractive optical element is a diffraction grating, prism, or aperture configured to diffract the emitted light.

19. The additive manufacturing system of claim 14, wherein the first range of wavelengths of light is between about 400 nanometers to 600 nanometers and the second range of wavelengths of light is between about 800 nanometers to 1000 nanometers.

20. The additive manufacturing system of claim 14, further comprising a second beam splitter configured to split the emitted light into a third range of wavelengths of light and wherein the second photosensitive detector is configured to sense the third range of wavelengths of light.

21. The additive manufacturing system of claim 20, wherein the second beam splitter is configured to split the emitted light into a fourth range of wavelengths of light, and further comprising a third photosensitive detector configured to sense the fourth range of wavelengths of light.

22. The additive manufacturing system of claim 20, wherein the third range of wavelengths of light is between about 1050 nanometers to about 1100 nanometers and the fourth range of wavelengths of light is between about 1500 nanometers to about 1700 nanometers.

23. The additive manufacturing system of claim 21, wherein the second beam splitter is configured to direct the third range of wavelengths of light to the second photosensitive detector and the fourth range of wavelengths of light to the third photosensitive detector.

24. The additive manufacturing system of claim 14, wherein the first photosensitive detector and the second photosensitive detector comprise a one-dimensional array of pixels.

25. A method for monitoring an additive manufacturing process, the method comprising:
directing laser energy from one or more laser energy sources onto a build surface;
emitting light from the build surface including a plurality of wavelengths of light;
diffracting the emitted light into a range of separate wavelengths of light; and
sensing the separate wavelengths of light on separate portions of a photosensitive detector.

26-37. (canceled)

38. An additive manufacturing system comprising:
a build surface;
one or more laser energy sources configured to direct laser energy onto the build surface, wherein light is emitted from the build surface including a plurality of wavelengths upon exposure to the laser energy;
a diffractive optical element configured to diffract the emitted light into a range of separate wavelengths of light; and
a photosensitive detector configured to sense the separate wavelengths of light on separate portions of the photosensitive detector.

39-48. (canceled)

49. A method for monitoring an additive manufacturing process, the method comprising:
directing laser energy from one or more laser energy sources onto a build surface;
directing a portion of the laser energy prior to the laser energy being incident on the build surface towards a photosensitive detector;
sensing the portion of the laser energy with the photosensitive detector; and
determining one or more parameters of the laser energy based at least in part on the sensed portion of the laser energy.

50-60. (canceled)

61. An additive manufacturing system comprising:
a build surface;
one or more laser energy sources configured to direct laser energy onto the build surface;
a beam splitter disposed between the one or more laser energy sources and the build surface configured to direct a portion of the laser energy towards a photosensitive detector, wherein the photosensitive detector is configured to sense the portion of the laser energy; and
a processor configured to:
determine one or more parameters of the laser energy based at least in part on the sensed portion of the laser energy.

62-67. (canceled)
